(19) United States
(12) Patent Application Publication
(10) Pub. No.: US 2010/0031176 A1
(43) Pub. Date: Feb. 4, 2010

(54) METHOD OF DEFINING FOCUS MOVEMENT ORDER AND MOVING FOCUS, AND COMPUTER READABLE RECORDING MEDIUM FOR EXECUTING THE METHOD

(75) Inventor: Dong-hyun SONG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/417,072

(22) Filed: Apr. 2, 2009

(30) Foreign Application Priority Data
Jul. 30, 2008 (KR) 10-2008-0074705

(51) Int. Cl. G06F 3/048

(52) U.S. Cl. 715/767; 715/234

(57) ABSTRACT

Provided are a method of defining a focus movement order and a method of moving a focus. The method of moving the focus, according to the present invention, includes multi-dimensionally grouping two or more focusable elements into two or more focusable groups; displaying the two or more focusable groups; receiving a tab input from a user; moving the focus to another focusable group according to the tab input; receiving a layer change request from the user; moving the focus to a focusable element or a lower-layer group, which are included in a currently focused group; receiving a tab input from the user; and moving the focus to another focusable element or a lower-layer group according to the tab input.

### CROSS-REFERENCE TO RELATED PATENT APPLICATION

This application claims priority from Korean Patent Application No. 10-2008-0074705, filed on Jul. 30, 2008, in the Korean Intellectual Property Office, the disclosure of which is incorporated herein in its entirety by reference.

### BACKGROUND OF THE INVENTION

1. Field of the Invention

The methods consistent with the present invention relate to moving a focus, and more particularly, to multi-dimensionally grouping focusable elements on a web document in order to promptly move a focus.

2. Description of the Related Art

Tab indexes in a web browser define a movement order of a focus. The tab indexes are applied to form-related tags, links, and images in Microsoft Internet Explorer™ and Mozilla Firefox™, which are representative examples of the web browser, and are applied to only the form-related tags in Opera of Opera Software. (According to the hyper text mark-up language (HTML) specification, the tab indexes are defined on <select>, <input>, <text area>, and <button>of a form. However, each web browser has implemented the specification differently) In a personal computer (PC) environment, a desired link or button on a web browser can be selected by using a pointing device such as a mouse or a touch pen (if a screen is a touch screen). In an environment not having a pointing device, for example, a television (TV), generally, a tab key on a key board or a certain key on a remote controller, which has a function of the tab key, has to be repeatedly pushed in order to access a certain link or button.

However, a normal web document, and in particular, a portal site has tens through thousands of focusable links and buttons making it highly inconvenient to access a desired link or button by the use of a tab key where no pointing device is available. The tab indexes are not set in normal web documents such that the movement order of a focus is defined according to the order in which the links, images, or buttons appear. Although tab indexes are set in a web browser, the structure of the tab indexes is one-dimensional and thus focus has to repeatedly move from one link or button to a neighboring link or button one by one until a desired link or button is reached.

A conventional method of moving a focus will now be described with reference to FIGS. 1A and 1B.

FIG. 1A is a computer screen image of a portal site including a plurality of focusable elements. FIG. 1B is a computer screen image showing a focus movement order of focusable elements included in the portal site illustrated in FIG. 1A, according to the related art.

Conventional tab indexes are represented in the form of a list having a series of one-dimensional integers. As illustrated in FIGS. 1A and 1B, the tab indexes in Google's search site (http://www.google.co.kr) are determined on <a>, <input>, <button>, etc. in reading order (left to right, top to bottom). Unless clearly set by a content creator, the tab indexes are applied to focusable elements (<a>, <input>, <button>, and <select>) in order from the left top to the bottom right of a web document. Thus, in an environment not having a pointing device, for example, if a user wants to visit an English version of the Google site from a current Korean version of the Google site, and then wants to search by a key word, the user has to access the twenty-sixth element of the site, “Google.com in English” (refer to a reference numeral 26 indicated in FIG. 1B) and then to move to the search box, which is the eighth element (refer to a reference numeral 8 indicated in FIG. 1B). At worst, a tab key or a button on a remote controller has to be pushed thirty four times. Accordingly, in order to move to a service that the user wants in a web page such as Naver site (http://www.naver.com) or Daum site (http://www.daum.net), which includes hundreds of tab indexes, a tab has to move n/2 times (n is a total number of the focusable elements) on an average.

Thus, in order to solve the above-described problem in an environment not having a pointing device, a method of efficiently defining tab indexes is necessary for a user to rapidly access a desired element.

### SUMMARY OF THE INVENTION

The present invention provides a method of defining a focus movement order in order to rapidly and easily move a focus and a method of moving the focus. Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

According to an aspect of the present invention, there is provided a focus movement order defining method including dividing two or more focusable elements into two or more groups; determining a focus movement order of the two or more groups; determining the focus movement order of focusable elements included in each group; and generating a focus movement order defining file in consideration of the groups and the focus movement order.

According to another aspect of the present invention, there is provided a focus moving method including displaying two or more focusable groups each of which includes one or more focusable elements; receiving a tab input from a user; and moving a focus to another focusable group according to the tab input.

According to another aspect of the present invention, there is provided a computer readable recording medium having recorded thereon a computer program for executing a focus movement order defining method including dividing two or more focusable elements into two or more groups; determining a focus movement order of the two or more groups; determining the focus movement order of focusable elements included in each group; and generating a focus movement order defining file in consideration of the groups and the focus movement order.

According to another aspect of the present invention, there is provided a computer readable recording medium having recorded thereon a computer program for executing a focus moving method including displaying two or more focusable groups each of which includes one or more focusable elements; receiving a tab input from a user; and moving a focus to another focusable group according to the tab input.

### BRIEF DESCRIPTION OF THE DRAWINGS

The above and other features and advantages of the present invention will become more apparent by describing in detail exemplary embodiments thereof with reference to the attached drawings in which:

FIG. 1A is a computer screen image of a portal site including a plurality of focusable elements;

FIG. 1B is a computer screen image showing a focus movement order of focusable elements included in the portal site illustrated in FIG. 1A, according to a related art;

FIG. 2 is a diagram showing a focus movement order of focusable elements, according to the related art;

FIG. 3 is a diagram for describing a method of multi-dimensionally grouping focusable elements, according to an exemplary embodiment of the present invention;

FIG. 4A is a computer screen image of a web document for describing a focus moving method according to an exemplary embodiment of the present invention;

FIG. 4B is a computer screen image of a web document for describing a layer changing method according to an exemplary embodiment of the present invention; and

FIG. 5 is a computer screen image of a web document obtained by reconstructing the portal site illustrated in FIG. 1A, according to an exemplary embodiment of the present invention.

### DETAILED DESCRIPTION OF AN EXEMPLARY EMBODIMENT OF THE INVENTION

Hereinafter, the present invention will be described in detail by explaining exemplary embodiments of the invention with reference to the attached drawings.

A focus movement order defining method and a focus moving method according to embodiments of the present invention may be applied to all types of electronic devices not having a pointing device, such as televisions (TVs) and printers. An electronic device to which the present invention is applied, can have a presentation function based on a mark-up language (for example, a hyper text mark-up language (HTML) or an extensible mark-up language (XML)). In more detail, an electronic device to which the present invention is applied, may include a browser and provide a graphic user interface (GUI) to present various web documents such as portal sites and to control the electronic device. One ordinarily skilled in the art would recognize that although an electronic device with a browser and GUI are described here, any device which can display a web document will suffice.

Initially, a focus movement order defining method according to an embodiment of the present invention will be described.

The focus movement order defining method is summarized as follows.

1) A plurality of focusable items included in a web page are divided into two or more groups.

2) A group focus movement order of the two or more groups is determined.

3) An element focus movement order of focusable elements included in each group is determined.

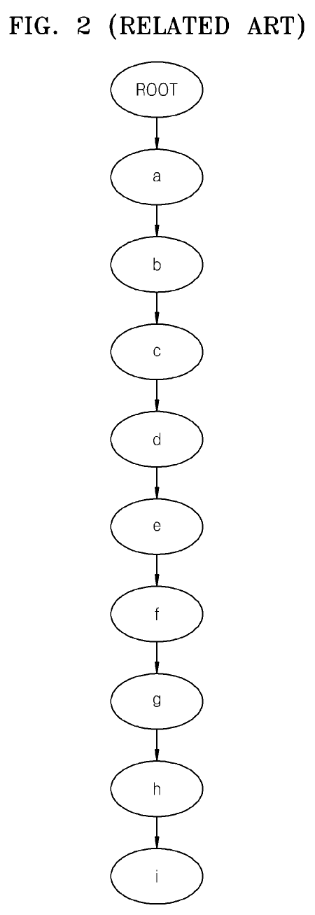

4) A focus movement order defining file is generated with reference to the groups, the group focus movement order, and the element focus movement order which are respectively determined in steps 1) through 3).

<Document 1>below shows a conventional tab indexing method. For example, if a document to be presented on a browser includes nine focusable elements a through i, the conventional tab indexing method defines a focus movement order by one-dimensionally arranging the focusable elements a through i (refer to FIG. 2) and generating a list. According to the conventional tab indexing method, a focus moves in an order of a→b→c→d→e→f→g→h→i.

<Document 1>

A : <INPUT name=“a” tabindex=“1”>
B : <INPUT name=“b” tabindex=“2”>
C : <INPUT name=“c” tabindex=“3”>
D : <INPUT name=“d” tabindex=“4”>
E : <INPUT name=“e” tabindex=“5”>
F : <INPUT name=“f” tabindex=“6”>
G : <INPUT name=“g” tabindex=“7”>
H : <INPUT name=“h” tabindex=“8”>
I : <INPUT name=“i” tabindex=“9”>

<Document 2>below shows another conventional tab indexing method. <Document 2>is different from <Document 1>in that tab indexes are not set to some elements b, d-f, h, and i of a plurality of focusable elements a through i. However, according to a conventional tab index ordering method, a tab order is initially given to focusable elements having tab indexes and then is given to focusable elements not having tab indexes. Thus, a focus movement order of <Document 2>is defined as a→c→g→b→d→c→f→h→i.

<Document 2>

A : <INPUT name=“a” tabindex=“1”>
B : <INPUT name=“b”>
C : <INPUT name=“c” tabindex=“2”>
D : <INPUT name=“d”>
E : <INPUT name=“e”>
F : <INPUT name=“f”>
G : <INPUT name=“g” tabindex=“3”>
H : <INPUT name=“h”>
I : <INPUT name=“i”>

A web document (or a file or contents) to which the present invention is applied, includes a plurality of focusable elements (for example, form-related tags, links, and images). Thus, in order to efficiently use tab indexes in an environment not having a pointing device, a new hierarchical (or multi-dimensional) focus movement order defining method is required instead of a conventional one-dimensional focus movement order defining (or tab indexing) method.

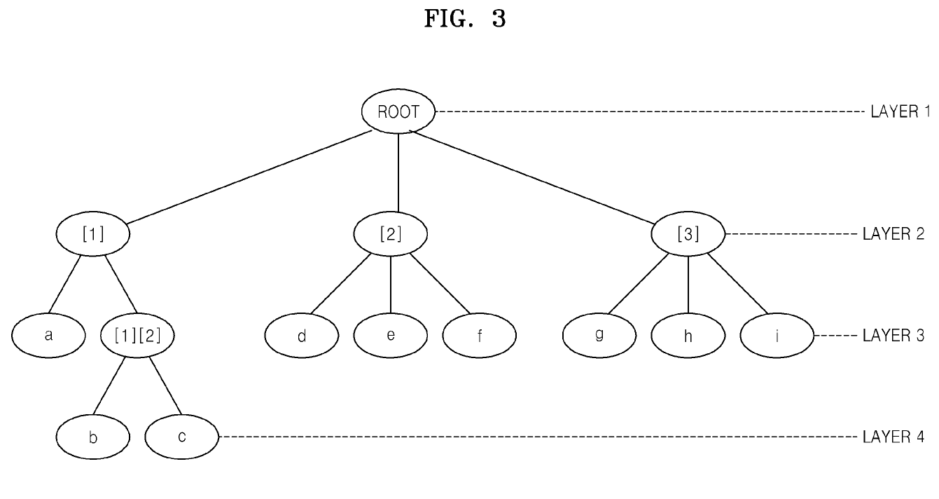

FIG. 3 is a diagram for describing a method of multi-dimensionally grouping focusable elements, according to an embodiment of the present invention.

Referring to FIG. 3, a web browser includes nine focusable elements a through i as in FIG. 2. A layer 1 is given to a root. The nine focusable elements a through i are divided into three upper-layer groups [1] through [3]. Each of the upper-layer groups [1] through [3] corresponding to a layer 2 is a virtual set including one or more focusable elements and/or lower-layer groups. For example, the upper-layer group [1] includes the focusable element a and a lower-layer group [1][2], and the lower-layer group [1][2] includes the focusable elements b and c.

If the focusable elements a through i are completely grouped, a group focus movement order of the upper-layer groups [1] through [3] is determined. For example, the upper-layer groups [1] through [3] has the group focus movement order of [1]→[2]→[3].

Then, an element focus movement order of focusable elements included in each of the upper-layer groups [1]through [3] is determined. For example, the element focus movement order of the upper-layer group [1] is determined as a→[1][2], the element focus movement order of the upper-layer group [2] is determined as d→e→f, and the element focus movement order of the upper-layer group [3] is determined as g→h→i. Furthermore, the element focus movement order of the lower-layer group [1][2] is determined as b→c.

The grouping and the focus movement order determining may be previously performed by a web document creator in consideration of, for example, features, created time, and user preference of the focusable elements a through i included in the web document.

Lastly, a focus movement order defining document (or file) is generated with reference to the upper-layer groups [1] through [3], the lower-layer group [1][2], the group focus movement order, and the element focus movement order. For this, according to an embodiment of the present invention, tab indexes may be clearly indicated by modifying or adding new attributes to a current tab index policy (for example, an HTML specification).

1) Focus Movement Order Defining Method 1

As a web document to which the present invention is applied, <Document 3>below shows a focus movement order defining method hierarchically representing tab indexes by using attributes indicating layers in a tag related to focusable elements. In more detail, this method gives a multi-dimensional value (for example, [2][3]) to a “tabindex” that is an attribute indicating a layer in a tag.

<Document 3>

A : <INPUT name=“a” tabindex=“[1][1]”>
B : <INPUT name=“b” tabindex=“[1][2][1]”>
C : <INPUT name=“c” tabindex=“[1][2][2]”>
D : <INPUT name=“d” tabindex=“[2][1]”>
E : <INPUT name=“e” tabindex=“[2][2]”>
F : <INPUT name=“f” tabindex=“[2][3]”>
G : <INPUT name=“g” tabindex=“[3][1]”>
H : <INPUT name=“h” tabindex=“[3][2]”>
I : <INPUT name=“i” tabindex=“[3][3]”>

<Document 4>below shows a focus movement order defining method similar to the focus movement order defining method of <Document 3>. Merely, ordering of some of sequential tab indexes is omitted. However, a focus movement order of <Document 4>is the same as the focus movement order of <Document 3>.

It would be very difficult for a content creator of a portal site to calculate and define tab indexes in order to give a tab order to hundreds of links and buttons one by one. Accordingly, time required to define a focus movement order may be reduced by using the tab indexing method of <Document 4>.

<Document 4>

A : <INPUT name=“a” tabindex=“[1]”>
B : <INPUT name=“b” tabindex=“[1][2]”>
C : <INPUT name=“c”>
D : <INPUT name=“d” tabindex=“[2]”>
E : <INPUT name=“e”>
F : <INPUT name=“f”>
G : <INPUT name=“g” tabindex=“[3]”>
H : <INPUT name=“h”>
I : <INPUT name=“i”>

2) Focus Movement Order Defining Method 2

<Document 5>

```
<TabGroup> // root
  <TabGroup> // [1]
    A : <INPUT name=“a”>
    <TabGroup> // [1][2]
    B : <INPUT name=“b”>
    C : <INPUT name=“c”>
    </TabGroup>
    </TabGroup>
    <TabGroup> // [2]
    D : <INPUT name=“d”>
    E : <INPUT name=“e”>
    F : <INPUT name=“f”>
    </TabGroup>
    <TabGroup> // [3]
    G : <INPUT name=“g”>
    H : <INPUT name=“h”>
    I : <INPUT name=“i”>
    </TabGroup>
  </TabGroup>
```

A focus movement order defining method of <Document 5>uses an additional tag for designating groups (for example, a tag of “Tab Group”). In more detail, a tab group is given to a group included in each layer and then focusable elements are arranged in corresponding groups.

3) Focus Movement Order Defining Method 3

The above focus movement order defining methods 1 and 2 use attributes of a tag included in a web document to be presented or add a new tag. That is, the focus movement order defining methods 1 and 2 are designed to internally manipulate a focus movement order. Unlike the focus movement order defining methods 1 and 2, according to another embodiment of the present invention, tab indexes may be constructed and manipulated by using external factors. In more detail, hierarchical tab indexes of a web page may be constructed by using a JavaScript file or a template file. As a cascade style sheet (CSS) file defines a layout of an HTML document, an additional document for controlling a focus movement order of an original web document is constructed and then the additional document is linked to the original document.

For example, a web document (<Document 6>) including focusable elements is linked to an external document (<Document 7>) for defining tab indexes by using a <link>tag from among HTML tags. Thus, focus movement order of <Document 6>is determined by the external document.

```
      <Document 6>
<link href=”./tabindex.css”></link>
    A : <INPUT name=“a” class=“c1”>
    B : <INPUT name=“b” class=“c2”>
    C : <INPUT name=“c” class=“c3”>
    D : <INPUT name=“d” class=“c4”>
    E : <INPUT name=“e” class=“c5”>
    F : <INPUT name=“f” class=“c6”>
    G : <INPUT name=“g” class=“c7”>
    H : <INPUT name=“h” class=“c8”>
    I : <INPUT name=“i”>
      <Document 7> (tabindex.css)
  #c1
  {
      Tabindex: [1];
  }
  #c2
  {
      Tabindex: [1][2];
  }
  #c4
  {
      Tabindex: [2];
  }
  #c7
  {
      Tabindex: [3];
  }
```

Hereinafter, a focus moving method according to an embodiment of the present invention will be described. Here, a focus movement order defining file generated by using a focus movement order defining method according to an embodiment of the present invention may be used.

The focus moving method is summarized as follows.

1) Two or more focusable groups are displayed.

2) A tab input for moving a focus (or cursor) between focusable groups is received from a user.

3) The focus moves to another focusable group according to the tab input.

4) The above steps 2) and 3) are repeated until the user reaches a desired focusable group.

5) A layer change (or group selection) request is received from the user.

6) The focus moves to a focusable element or a lower-layer group, which are included in a currently focused group.

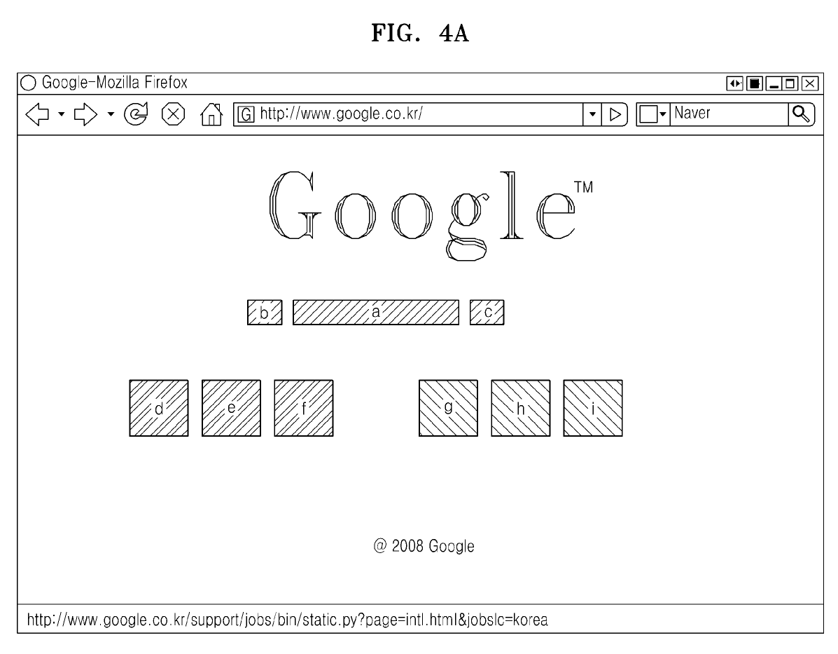

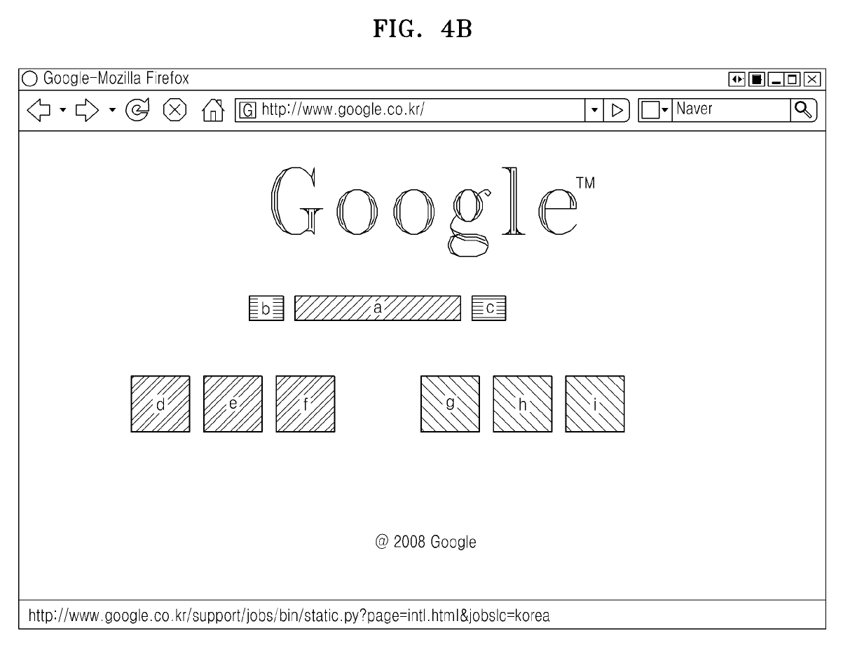

FIG. 4A is a computer screen image of a web document for describing a focus moving method according to an embodiment of the present invention. FIG. 4B is a computer screen image of a web document for describing a layer changing method according to an embodiment of the present invention.

Focusable elements are divided into a plurality of focusable groups and the focusable groups have to be displayed such that a user may recognize the focusable groups.

Referring to FIG. 4A, focusable elements a through i are divided into three focusable groups [1] through [3]. The focusable group [1] may include the focusable elements a through c (here, the focusable elements b and c may be further included in a lower-layer group [1][2]), the focusable group [2] may include the focusable elements d through f, and the focusable group [3] may include the focusable elements g through i. The focusable groups [1] through [3] are displayed such that each of the focusable groups [1] through [3] is identified from the other focusable groups.

When a cursor (or focus) is located at the focusable group [1], if the user wants to select the focusable group [2] or the focusable group [3], the user has to push a tab key and the cursor moves to the focusable group [2] and then to the focusable group [3] in response to the tab key.

Unlike a conventional tab indexing method, according to an embodiment of the present invention, the focusable elements a through i have a multi-dimensional structure (or a plurality of layers) and thus a mechanism for changing layers or selecting a focusable group is required. When the cursor is currently located at the focusable group [1] (the layer 2 of FIG. 3), if the user ultimately wants to move to the focusable element a (the layer 3 of FIG. 3), a predetermined key for changing layers is required in addition to the tab key. Thus, functions for changing layers have to be mapped to one or more keys (a key for moving to an upper layer and a key for moving to a lower layer) on a key board or a remote controller, in advance.

When the cursor is located at the focusable group [1], if the user inputs the key for moving to an upper layer, the focus moves to the layer 3 while the focusable group [1] is being selected. Since the focusable group [1] includes the focusable element a and the lower-layer group [1][2], the focusable element a and the lower-layer group [1][2] are displayed so as to be identified from each other as illustrated in FIG. 4B. When the cursor is currently located at the focusable element a, if the user inputs a key for changing layers (or a third key for selecting a focusable element), the focusable element a would be ultimately selected. However, if the user pushes the tab key, the cursor would move to the lower-layer group [1][2]. It should be noticed that the tab key cannot move the focus (or cursor) to another layer. Based on the above example, although the tab key is repeatedly pushed, the cursor would move only between the focusable element a and the lower-layer group [1][2] and would not move to the focusable group [1] that is a parent layer, or to the focusable elements b or c which are child layers.

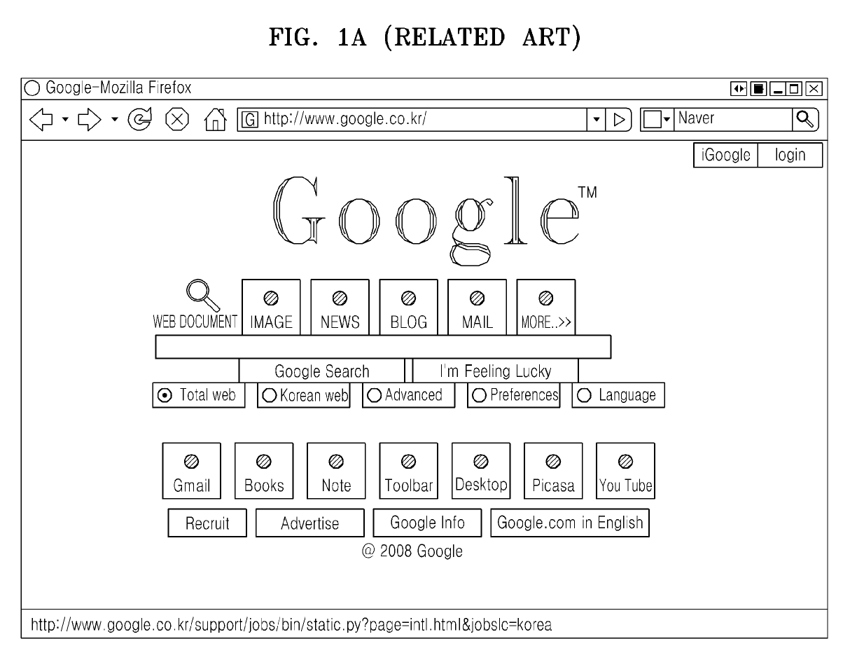

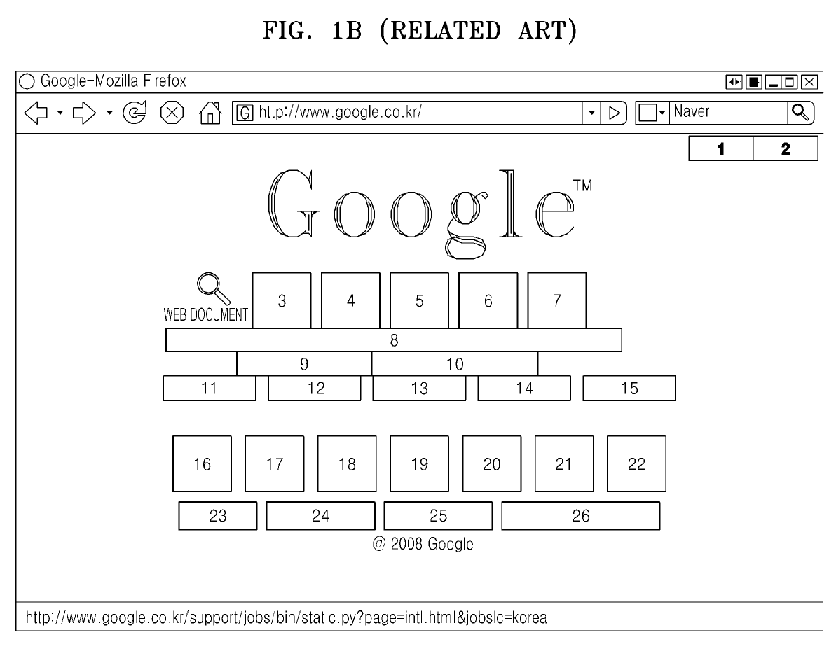

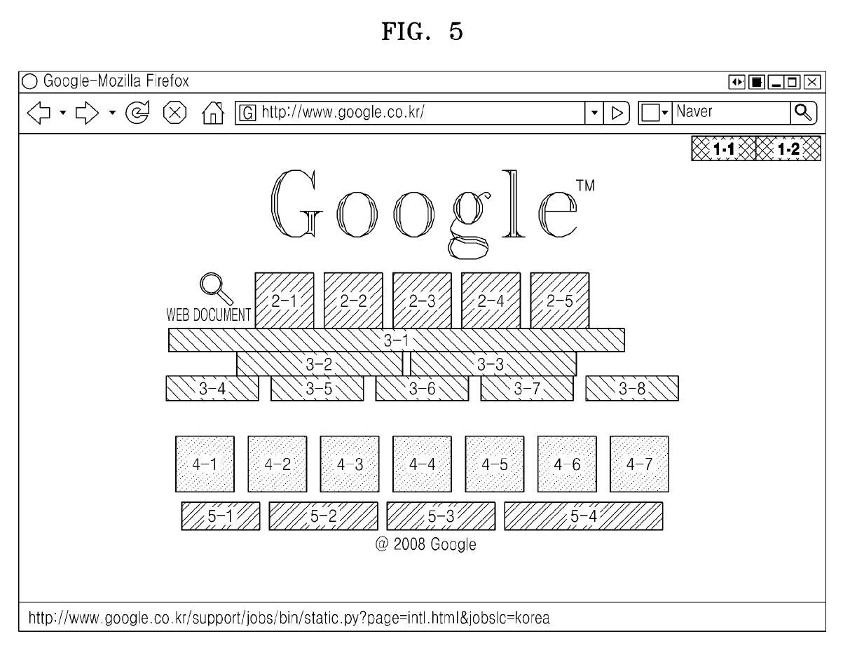

FIG. 5 is a computer screen image of a web document obtained by reconstructing the portal site illustrated in FIG. 1A, according to an embodiment of the present invention.

Referring to FIG. 5, totally twenty six focusable elements are divided into five focusable groups. According to the focus moving method of the present invention, the number of key inputs for selecting a focusable element is greatly reduced in comparison to the related art. For example, in FIG. 1B, according to the related art, if a user wants to visit an English version of the Google site from a current Korean version of the Google site, and then to search by a key word, a total of thirty four key presses are necessary. However, according to the current embodiment (FIG. 5) of the present invention, the same process may be performed by approximately ten key presses.

The above-described focus movement order defining method according to the present invention can be implemented by modifying a web document forming policy (for example, an HTML specification) or can be implemented by adding this particular function as a plug-in to a browser. Thus, the focus movement order defining method according to the present invention can be implemented as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. One ordinarily skilled in the art would recognize that although ROM, RAM, CD-Rom, tapes, floppy disks and optical storage devices are described here, any computer-readable recording medium will suffice. In addition, one ordinary skilled in the art would recognize that any computer readable transmission medium, such as a carrier wave, will suffice.

As described above, according to the present invention, if an electronic device not having a pointing device, such as a television or a printer, provides an application or a user interface, which uses a browser technology, a focusable element of a web document may be easily and rapidly accessed.

Also, an external document may define tab indexes of a web document (refer to the Focus Movement Order Defining Method 3 above) and thus a user may select various desired operation scenarios.

While the present invention has been particularly shown and described with reference to exemplary embodiments thereof, it will be understood by one ordinarily skilled in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A focus movement order defining method comprising:
dividing two or more focusable elements into two or more groups;
determining a focus movement order of the two or more groups; and
determining the focus movement order of focusable elements comprised in each group.

2. The focus movement order defining method of claim 1, further comprising generating a focus movement order defining file in consideration of the groups and the focus movement order.

3. The focus movement order defining method of claim 2, wherein the focus movement order defining file defines an attribute indicating a layer of each focusable element in a tag by using the groups and the focus movement order.

4. The focus movement order defining method of claim 3, wherein the attribute indicating a layer is a tab index.

5. The focus movement order defining method of claim 2, wherein the focus movement order defining file defines the groups and the focus movement order by using a tag for designating groups.

6. The focus movement order defining method of claim 5, wherein the tag for designating groups is a tag of tab group.

7. The focus movement order defining method of claim 2, wherein the generating of the focus movement order defining file comprises generating an additional file for controlling the focus movement order by using the groups and the focus movement order.

8. The focus movement order defining method of claim 7, wherein the additional file is generated by using a JavaScript file or a template file.

9. The focus movement order defining method of claim 2, wherein the focus movement order defining file multi-dimensionally groups the two or more focusable elements.

10. The focus movement order defining method of claim 9, wherein the focus movement order defining file constructs the two or more focusable elements in a plurality of layers.

11. The focus movement order defining method of claim 2, wherein the focus movement order defining file is a document based on a mark-up language.

12. A focus moving method comprising:
displaying two or more focusable groups each of which comprises one or more focusable elements;
receiving an input from a user; and
moving a focus to another focusable group according to the input.

13. The focus moving method of claim 12, further comprising:
receiving a layer change request from the user; and
moving the focus to a focusable element or a lower-layer group, which are included in a currently focused group.

14. The focus moving method of claim 13, comprising:
receiving a tab input from the user; and
moving the focus to another focusable element or a lower-layer group according to the tab input.

15. The focus moving method of claim12, wherein the two or more focusable groups are displayed so as to be identified from each other.

16. The focus moving method of claim13, further comprising displaying the focusable element and the lower-layer group so as to be identified from each other.

17. The focus moving method of claim13, further comprising setting a predetermined button of a user's input tool, as a button for changing layers.

18. A computer readable recording medium having recorded thereon a computer program for executing a focus movement order defining method comprising:
dividing two or more focusable elements into two or more groups;
determining a focus movement order of the two or more groups; and
determining the focus movement order of focusable elements comprised in each group.

19. A computer readable recording medium having recorded thereon a computer program for executing a focus moving method comprising:
displaying two or more focusable groups each of which comprises one or more focusable elements;
receiving an input from a user; and
moving a focus to another focusable group according to the input.
